(19) United States
(12) Patent Application Publication
(10) Pub. No.: US 2013/0345842 A1
(43) Pub. Date: Dec. 26, 2013

(54) EARPHONE REMOVAL DETECTION

(71) Applicants: Elif Karakaya, Raleigh, NC (US); John Weldon Nicholson, Cary, NC (US); John Miles Hunt, Raleigh, NC (US); Song Wang, Cary, NC (US)

(72) Inventors: Elif Karakaya, Raleigh, NC (US); John Weldon Nicholson, Cary, NC (US); John Miles Hunt, Raleigh, NC (US); Song Wang, Cary, NC (US)

(73) Assignee: LENOVO (SINGAPORE) PTE. LTD., Singapore (SG)

(21) Appl. No.: 13/532,639

(22) Filed: Jun. 25, 2012

(51) Int. Cl. G06F 17/00

(52) U.S. Cl. 700/94

(57) ABSTRACT

An aspect provides a method, including: detecting that a first earphone and a second earphone are not both positioned in a listening position with respect to a user; generating a signal in response to detecting that a first earphone and a second earphone are not both positioned in a listening position with respect a user; and in response to the generated signal, halting an application on a device providing audio to the first earphone and second earphone. Other aspects are described and claimed.

### BACKGROUND

The subject matter described herein deals generally with detecting removal of earphones with respect to a user's ears. A variety of listening devices are known for use in connection with an information handling device such as a smart phone, a laptop computer, a table computer, an MP3 player and the like. One category of listening device is that having connected earphones (headphones) whereby the earphones are connected as a set with a band of material that assists in securing the listening device to the user's head, with the earphones appropriately positioned at the ears of the user. Another category of listening device is one having earphones (also referred to as ear buds) that are not connected to one another save via a wire. Generally each type of listening device connects to the information handling device via a wired connection, although wireless connected listening devices, for example a BLUETOOTH device, are known. The listening device connects to an information handling device, such as the examples listed above, such that the user can hear audio from an application running on the information handling device. As is apparent from the example short range wireless device example, the listening device may have components supporting other functionality, such as a microphone, micro processor and the like to support additional functionality, such as making voice calls with a paired handset.

When users are playing audio or video on their information handling devices, or otherwise using an application thereof that plays audio in some form, they have their headphones plugged into the jack of the device and fitted into or on their ears (one ear or both ears). Often, the user needs or wants to take off their headphones or take one or both of the earphones out of their ears without disconnecting the wired connection of the listening device from the device jack. Often users perform this function quickly such that they don't have time to go back to what they have been listening to or watching in order to pause the application, for example an MP3 player application. Thus, player stays on without them being able to follow it.

### BRIEF SUMMARY

In summary, one aspect provides a method, comprising: detecting that a first earphone and a second earphone are not both positioned in a listening position with respect to a user; generating a signal in response to detecting that a first earphone and a second earphone are not both positioned in a listening position with respect a user; and in response to the generated signal, halting an application on a device providing audio to the first earphone and second earphone.

Another aspect provides an information handling device, comprising: one or more processors; and a memory in operative connection with the one or more processors that stores instructions executable by the one or more processors to perform acts comprising: detecting that a first earphone and a second earphone are not both positioned in a listening position with respect to a user; generating a signal in response to detecting that a first earphone and a second earphone are not both positioned in a listening position with respect a user; and in response to the generated signal, halting an application on a device providing audio to the first earphone and second earphone.

A further aspect provides a program product, comprising: a storage medium having program code embodied therewith, the program code comprising: program code configured to detect that a first earphone and a second earphone are not both positioned in a listening position with respect to a user; program code configured to generate a signal in response to detecting that a first earphone and a second earphone are not both positioned in a listening position with respect a user; and program code configured to, in response to the generated signal, halt an application on a device providing audio to the first earphone and second earphone.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device.

FIG. 2 illustrates another example information handling device.

FIG. 3 illustrates an example halt signal processing circuit.

FIG. 4 illustrates an example method for monitoring listening positions of earphones and generating a halt signal.

FIG. 5 illustrates an example of listening device with connected earphones.

FIG. 6 illustrates an example listening device halting system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

At the outset, a listening device as referred to herein is meant to include any device that plays audio for a user locally, that is, at the user's ears, in connection with a connected (wired or wireless) information handling device running an application. Thus, a listening device may be a pair of headphones or ear buds, but likewise may include single ear BLUETOOTH personal network devices that support other functionality, such as for making telephone calls on a voice application running on a connected smart phone or tablet device. Additionally, the terms earphones and headphones are used interchangeably herein, and have the meaning of a set of (two) earphones that are connected in some way, either by an additional component such as a head band type connection or via a split wire connection, or both. Furthermore, the term halting includes not only pausing or stopping the audio generating application, but may also include providing a notification to the user or another user, or some suitable combination of the foregoing, as further described herein.

There are several of existing approaches to halting an audio generating application on an information handling device in addition to a user manually stopping the application. Looking over these existing approaches, it can be seen that there exists TRRS type plugs for connecting some listening devices to an audio jack of an information handling device. For these plugs, when the ring in the jack contacts with the plug body, the input is correctly grounded. Therefore, a switch contact within the panel socket can be used to close the circuit when the patch point is not in use. Current applications pause music players when the user unplugs his/her headphones from the device jack automatically. This method uses a circuit that detects that the microphone signal has been shorted to ground (referred to as a mic-short-to-ground mechanism), which happens as the microphone ring of the plug connects to the ground sleeve of the audio jack. Hence the audio is paused when the plug is removed from the jack. However, it is often inappropriate to remove the plug in order to facilitate a pause.

Another existing earphone (motion activated headphones) technology includes motion sensors in the earphones to detect motion such that a music player is paused when a user takes one earphone out. However, this only works with mobile phones of a single brand and switches back to a call mode when one earphone is inside the ear, neglecting the fact for example that the user might also want to listen to the music with only one of the earphones in the ear. Furthermore, the motion detected by the motion sensors in the headphones may be the listener's head moving, hence leading to false detection of motion indicating the music player should be paused.

There is another approach based on a signal mechanism that detects the repositioning of an earphone depending on the pressure change. This approach, in addition to other drawbacks relating to potentially inaccurate pressure readings and presupposing the user is using a listening device that has ear buds that fit into an ear canal, pauses a music player if even one earphone is removed from the ear canal.

However a user may want an application to halt only when both earphones are removed or the listening device plug is removed from the audio jack. Conventional approaches do not provide such functionality. Accordingly, an embodiment provides that, in response to a user removing both earphones from a listening position (proximate to or within the ears), the listening device sends a signal to the information handling device hosting the audio originating application to pause or otherwise halt accordingly. In this way, an embodiment ensures that the user doesn't miss what was being played by experiencing a delay in halting the application and doesn't have to go back and rewind to find a missed part of the audio.

The illustrated example embodiments will be best understood by reference to the figures. The following description is intended only by way of example, and simply illustrates certain example embodiments.

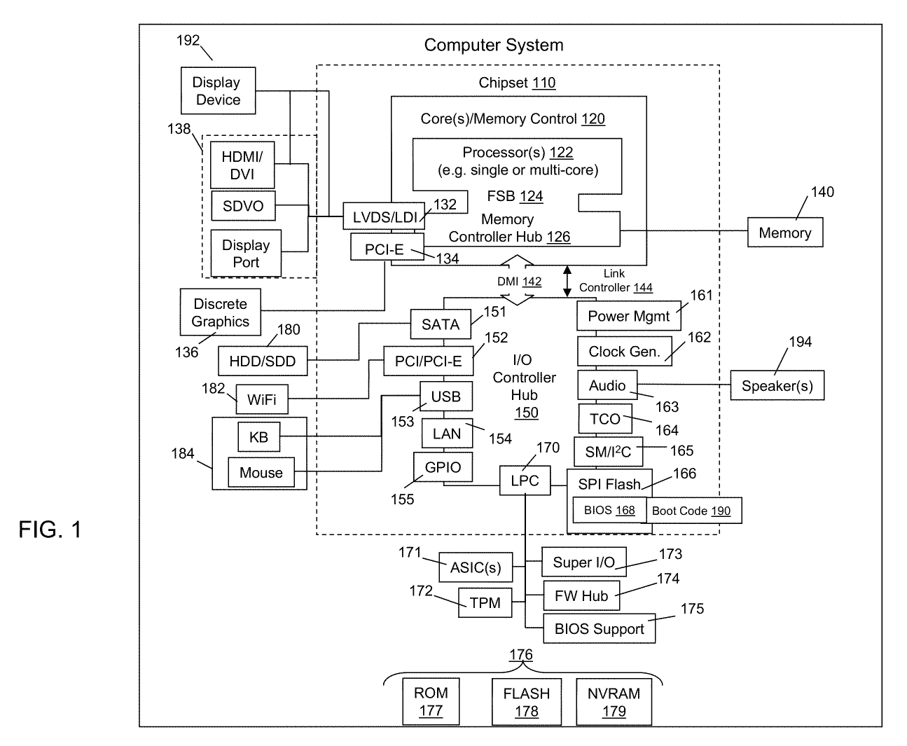

While various other circuits, circuitry or components may be utilized, FIG. 1 depicts a block diagram of one example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

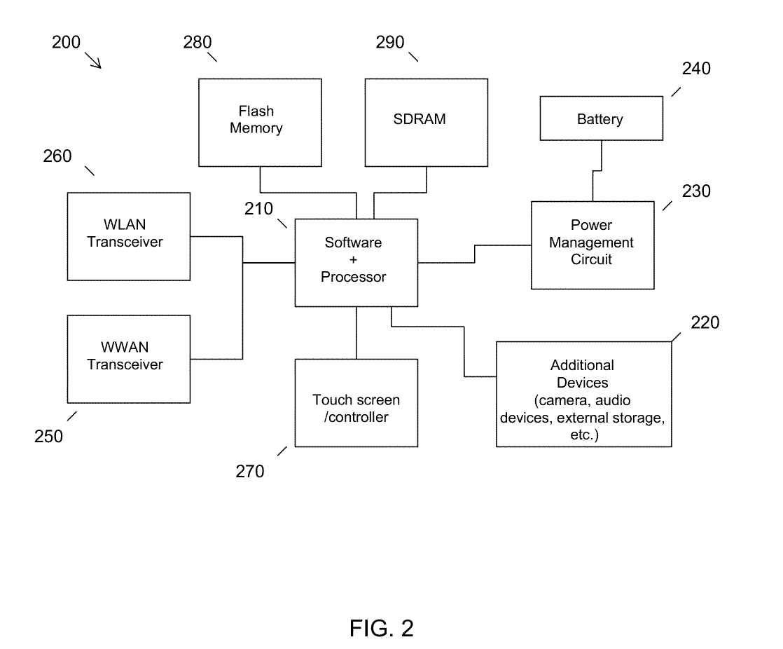

For example, referring to FIG. 2, with regard to smart phone and/or tablet circuitry 200, an example includes an ARM based system (system on a chip) design, with software and processor(s) combined in a single chip 210. Internal busses and the like depend on different vendors, but essentially all the peripheral devices (220) may attach to a single chip 210. In contrast to the circuitry illustrated in FIG. 1, the tablet circuitry 200 combines the processor, memory control, and I/O controller hub all into a single chip 210. Also, ARM based systems 200 do not typically use SATA or PCI or LPC. Common interfaces for example include SDIO and I2C. There are power management chip(s) 230, which manage power as supplied for example via a rechargeable battery 240, which may be recharged by a connection to a power source (not shown), and in at least one design, a single chip, such as 210, is used to supply BIOS like functionality and DRAM memory.

ARM based systems 200 typically include one or more of a WWAN transceiver 250 and a WLAN transceiver 260 for connecting to various networks, such as telecommunications networks and wireless base stations. Commonly, an ARM based system 200 will include a touch screen 270 for data input and display. ARM based systems 200 also typically include various memory devices, for example flash memory 280 and SDRAM 290.

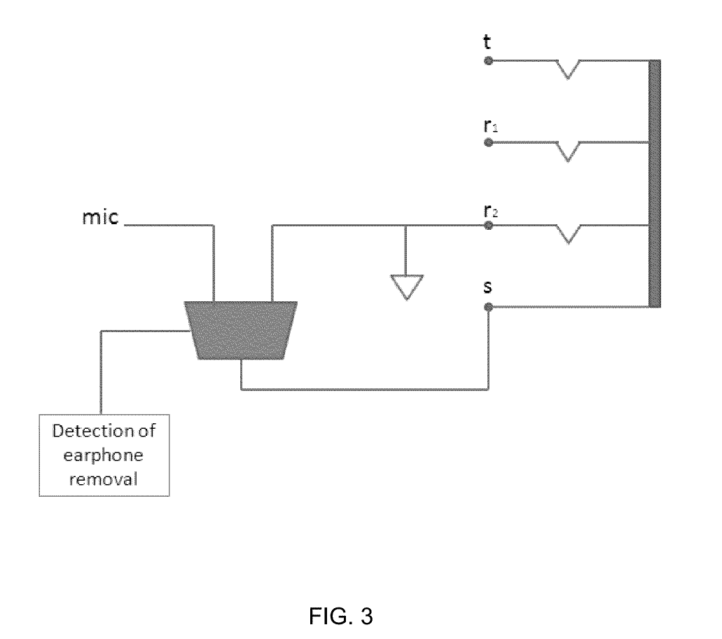

Referring to FIG. 3, an example of a halt signal processing circuit is illustrated. An embodiment provides a halt signal to an application of an information handling device in response to detecting that both earphones are not in the listening position. Thus, an embodiment will detect earphones being removed out of the user's ears and halt an application. The example mechanism illustrated in FIG. 3 will cause the halt signal to be seen similar to the removal of the earphone plug from the audio jack. Thus, the current mic-short-to-ground mechanism that pauses the players as the earphones are unplugged out of the audio jack may stay unmodified, and the earphones can mimic the headset unplugging behavior in response to the user removing the earphones by using the illustrated mic-short-to-ground like mechanism (that is, the signal generated in response to removal of both earphones may be interpreted as a mic-short-to ground signal).

This way, the earphones will have an additional feature that will make an information handling device application pause if the earphones are still in the jack but not in the ears. Thus, the earphones will work in (and pause) current media players that are being used without unnecessary modifications to the audio jack. That is, if either both of the earphones are out of the user's ear, or if the earphones are unplugged from the audio jack, the microphone and the ground will be shorted out and the absence of the earphones will be detected. To simulate the shorting of the microphone input when the earphones are removed from the ear, the example circuit illustrated in FIG. 3 may be utilized.

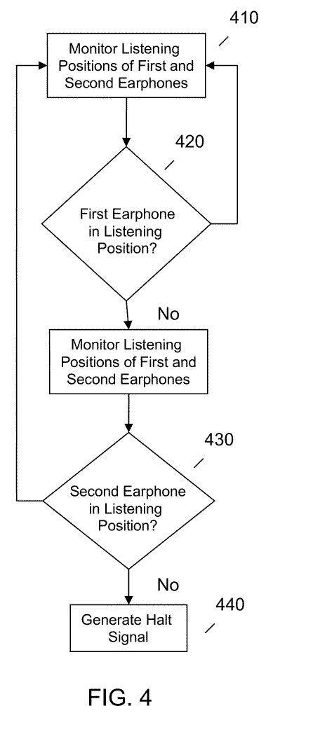

Illustrating in FIG. 4 is an example method for generating a halt signal. At 410, an embodiment monitors the listening positions of the earphones, as described further herein. At 420 an embodiment detects that a first of the two earphones is not in the listening position, that is in the user's ear canal or positioned on the user's ear, as further described herein. At 430 an embodiment detects that a second of the two earphones is not in the listening position. If both the first and second earphones are not in the listening position, at 440 an embodiment generates the halt signal to activate a mechanism for halting an application on a connected information handling device, such as the example mic-short-to-ground like mechanism illustrated in FIG. 3.

Embodiments may detect that the first and the second earphones are not in the listening position in a variety of ways. An embodiment may use biometric characteristics, either alone or in combination, for determining if the earphones are in the listening position. For example, as the ear is a part of the user's body, it will have the same temperature as the body temperature. An embodiment measures the temperature of the user's ear, for example at the earlobes or other appropriate location, with a temperature sensor placed in the earphones. As long as the sensed temperature is close to the body temperature, the halt signal is not generated and the information handling device application such as a media player is not halted but is kept running. In contrast, if the temperature goes below the body temperature or otherwise outside of a predetermined temperature range, the halt signal is generated and the player is paused or otherwise halted.

An embodiment may use a pulse detection mechanism as a biometric characteristic to determine if the first and second earphones are in the listening position. For example, from the part where the earphones touch the user's ears, sensors are placed to detect the heartbeat of the user. If there is a heartbeat detected, this will prevent the halt signal from being detected, and an application such as a media player will not be halted.

An embodiment may use detected contact with the user's skin as a biometric characteristic to determine that the first and second earphones are not in the listening position. For example, small metal contacts can be placed in the earphones to touch the user's ears and the ear skin can be used as a bridge to complete a circuit. An embodiment measures the resistance such that if the earphones are taken out of contact with the user's ears and the circuit is interrupted, an open circuit is detected and the mechanism takes effect to generate the halt signal and pause the application.

An embodiment may use an acoustic characteristic to detect that the first and second earphones are not in the listening position. For example, echo detection may be implemented as an acoustic characteristic based detection that the first and second earphones are not in the listening position. Because the earphones, in an ear bud implementation, will be positioned in the ear canal, the sound produced by the speakers in the earphone hits the ear drum and the sound bounces or echoes back and forth inside the listener's ears in a small distance. Hence, the echo of the sound coming from the ear bud speaker sounds different when inside the ear than when outside of it. In order to make use of that, additional acoustic receivers are put inside the earphones, such that the echo content of the sound waves can be utilized as a detection parameter for the location of the earphones.

An embodiment may also use frequency and amplitude based acoustic characteristics to detect that the earphones are not in the listening position. For example, sound waves dissipate their high frequencies as they propagate long distances. Inside the ear sound dissipation from the speaker of the earphone is different than when the earphone is outside of the ear. The ear canal for example is a smaller/short environment when compared to the space outside the ear canal. As a result, an embodiment may include an additional frequency detector inside the earphones. Thus, if the frequency detectors detect, based on sound dissipation of the high frequency components of the sound, then this will result in a detection that the earphone has been removed from the user's ear. Such a sound dissipation detection may be used by an embodiment to generate the halt signal.

Similarly, when a user inserts an ear bud into the ear canal, it has the effect of increasing the decibel level of the sound generated by the earphone speaker. This happens because less sound is dispersed and more of it reaches to the eardrum. Therefore, an embodiment may employ an additional microphone inside the headphones to measure the dB content of the sound within the ear canal and compare the strength of the sound to when the earphone is outside the ear. An embodiment turns this comparison into an indicator of ear buds' locations. For example, in using the comparison, when the strength decreases, the halt signal may be generated as appropriate.

An embodiment may place additional microphones in active noise canceling headphones, which currently have microphones inside the ear buds listening to external sounds. In an embodiment, the additional microphones are placed outside of headphones in order to listen to the sound coming from the speakers. This way, the microphones can hear the sound coming from the speakers when the headphones are off of or outside of the user's ears and they cannot hear the sound when the earphones are on or inside the ears. Thus, depending on this difference in sound detection, if the microphones can detect the speakers' sound, an embodiment may then determine that the headphones are not in the listening position and the application may be paused or otherwise halted. Similarly, microphones placed both outside of (listening to external noise) and inside of (listening to internal speaker audio) headphones may be used to compare the sound from the various external and internal microphones. When there is a match, it may indicate that the earphones are not in the listening position and used to generate a halt signal.

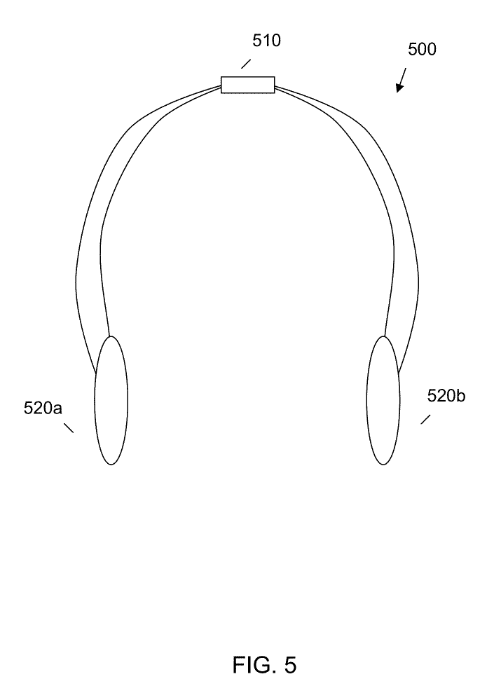

Referring to FIG. 5, in a connected earphone or headphone arrangement 500, an embodiment may use a sensor 510 to detect if the earphones are in the listening position. For example, the sensor may sense stretch (using a stretch sensor) or otherwise determine (or example, determined orientation using an accelerometer) that the headband is flexed or oriented appropriately for indicating use of the earphones on the user's head. Thus, in response to detecting flexing or like indicator of the headband by the sensor, an embodiment may prohibit the halt signal from being generated because the earphones 520a and 520b are detected to be in the listening position. If the sensor 510 does not detect such stretching or other indicator of proper listening orientation or position, or detects a change in orientation (such as a lower amount of stretch after being in a stretched position), an embodiment may generate the halt signal and halt an application running on a host device.

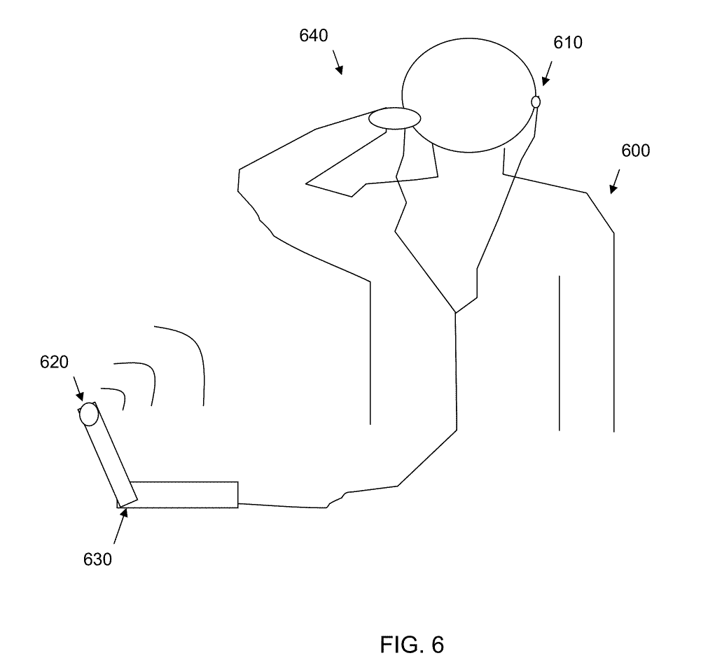

Referring to FIG. 6, embodiments may utilize additional devices for detecting that the earphones are not in the listening position. For embodiments that use external components (such as for example an external sensor, as for example provided by a PC camera with motion detection software or an infrared receiver), a halt signal may take the form of a pause event/request that is sent to the operating system (OS) using an appropriate HID interface. This may be used instead of making use of the switch mechanism of earphones, as described herein with reference to FIG. 3.

When using earphones (ear buds are illustrated in the non-limiting example of FIG. 6), the user 600 may decide to take the earphones 610 (only one is visible in the view of FIG. 6) out of the ear. An embodiment may employ a camera 620 of a connected information handling device, such as a laptop computer 630, to track the user movements, such as a user placing a hand to the ear 640 to remove the earphones. Thus, an embodiment may use a visual based detection mechanism to detect the motion of removing the earphones out of the ears. An embodiment needs to visually detect both of the listener's hands as he/she pulls the earphones out of his/her ears in order to generate the halt signal. Once the camera detects this, the halt signal may be generated and the application on the connected information handling device 630 may be halted.

Similarly, infrared sensors embedded to the computer, for example in position 620 corresponding the location of the camera, and to the earphones (transmitters not illustrated in the earphones for simplicity) and these can be used to send and receive signals from each other and discover each others' relative positions. In response to the sensor receiving an indication that the earphones are not positioned in a position consistent with the listening position, the halt signal may be generated and the application on the information handling device 630 halted.

Similarly, an embodiment may apply similar methods for BLUETOOTH headsets or like devices running on battery power to turn them off or reduce their power consumption while such devices are not in the listening position. For example, an embodiment may then turn the BLUETOOTH radio back on once the user puts the headset on, and hence save battery. This approach may also be used for calls during which the listener uses earphones (with or without a BLUETOOTH headset). For example, an embodiment may alert the speaker if and/or when the user removes the earphones from his/her ears. A warning may be sent to either user on the call. For example, an embodiment may warn the user that removing both earphones will cause disruption of the phone application. An embodiment may also warn the user on the other end of the call that the user has removed the earphones and cannot hear.

Accordingly, embodiments provide arrangements that allow for the detection of when the earphones are not in the listening position. In response to such detection, a signal may be generated. The example detection approaches described herein may be used in any suitable combination with one another. The signal may be used to halt an application on an information handling device that generates audio, including for example providing warnings to the user(s) using the application. The halt signal may be generated within the listening device itself or may be generated at the host device, or a suitable combination thereof. Indications that the earphones are not in the listening position may be detected at the earphones, at the host device, or a suitable combination of the foregoing.

If the indication is detected in the earphones, such as for example via acoustic or biometric characteristic based detection, as described herein, the indication and/or the halt signal may be transmitted via separate wireless or wired channel to the host device, or signals may be multiplexed with the audio or voice signals normally employed by the earphones to support audio and voice functionality, or some suitable combination of the foregoing.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting that a first earphone and a second earphone are not both positioned in a listening position with respect to a user;
generating a signal in response to detecting that a first earphone and a second earphone are not both positioned in a listening position with respect a user; and
in response to the generated signal, halting an application on a device providing audio to the first earphone and second earphone.

2. The method of claim 1, wherein the generated signal is interpreted as a mic-short-to ground signal.

3. The method of claim 1, wherein detecting that a first earphone and a second earphone are not both positioned in a listening position with respect to a user further comprises:
detecting that an acoustic characteristic of the first earphone indicates that the first earphone is not positioned in a listening position with respect to a user; and
detecting that an acoustic characteristic of the second earphone indicates that the second earphone is not positioned in a listening position with respect to the user.

4. The method of claim 3, wherein the acoustic characteristic is frequency based.

5. The method of claim 3, wherein the acoustic characteristic is amplitude based.

6. The method of claim 3, wherein the acoustic characteristic is based on comparing sound samples derived from a microphone positioned to sample external audio and from a microphone positioned to sample internal audio.

7. The method of claim 1, wherein detecting that a first earphone and a second earphone are not both positioned in a listening position with respect to a user further comprises:
detecting that a biometric characteristic of the first earphone indicates that the first earphone is not positioned in a listening position with respect to a user; and
detecting that a biometric characteristic of the second earphone indicates that the second earphone is not positioned in a listening position with respect to the user.

8. The method of claim 7, wherein the biometric characteristic is based on a lack of detectable pulse.

9. The method of claim 7, wherein the biometic characteristic is one or more of temperature based and lack of skin contact based.

10. The method of claim 1, wherein the generated signal is a visual based detection signal generated by one or more additional devices.

11. An information handling device, comprising:
one or more processors; and
a memory operatively coupled with the one or more processors that stores instructions executable by the one or more processors to perform acts comprising:
detecting that a first earphone and a second earphone are not both positioned in a listening position with respect to a user;
generating a signal in response to detecting that a first earphone and a second earphone are not both positioned in a listening position with respect a user; and
in response to the generated signal, halting an application on a device providing audio to the first earphone and second earphone.

12. The information handling device of claim 11, wherein the generated signal is interpreted as a mic-short-to ground signal.

13. The information handling device of claim 11, wherein detecting that a first earphone and a second earphone are not both positioned in a listening position with respect to a user further comprises:
detecting that an acoustic characteristic of the first earphone indicates that the first earphone is not positioned in a listening position with respect to a user; and
detecting that an acoustic characteristic of the second earphone indicates that the second earphone is not positioned in a listening position with respect to the user.

14. The information handling device of claim 13, wherein the acoustic characteristic is frequency based.

15. The information handling device of claim 13, wherein the acoustic characteristic is amplitude based.

16. The information handling device of claim 13, wherein the acoustic characteristic is based on comparing sound samples derived from a microphone positioned to sample external audio and from a microphone positioned to sample internal audio.

17. The method of claim 11, wherein detecting that a first earphone and a second earphone are not both positioned in a listening position with respect to a user further comprises:
detecting that a biometric characteristic of the first earphone indicates that the first earphone is not positioned in a listening position with respect to a user; and
detecting that a biometric characteristic of the second earphone indicates that the second earphone is not positioned in a listening position with respect to the user.

18. The method of claim 17, wherein the biometic characteristic is one or more of lack of detectable pulse, temperature based and lack of skin contact based.

19. The method of claim 1, wherein the generated signal is a visual based detection signal generated by one or more additional devices.

20. A program product, comprising:
a storage medium having program code embodied therewith, the program code comprising:
program code configured to detect that a first earphone and a second earphone are not both positioned in a listening position with respect to a user;
program code configured to generate a signal in response to detecting that a first earphone and a second earphone are not both positioned in a listening position with respect a user; and
program code configured to, in response to the generated signal, halt an application on a device providing audio to the first earphone and second earphone.
